(19) United States
(12) Patent Application Publication
(10) Pub. No.: US 2025/0039877 A1
(43) Pub. Date: Jan. 30, 2025

(54) INDICATING MEASUREMENT GAP SKIPPING

(71) Applicant: QUALCOMM Incorporated, San Diego, CA (US)

(72) Inventors: Diana MAAMARI, San Diego, CA (US); Huilin XU, Temecula, CA (US); Ahmed ELSHAFIE, San Diego, CA (US); Hyun Yong LEE, San Diego, CA (US); Mickael MONDET, Louannec (FR); Prashanth Haridas HANDE, San Diego, CA (US)

(21) Appl. No.: 18/359,703

(22) Filed: Jul. 26, 2023

(51) Int. Cl. H04W 72/20

(52) U.S. Cl. CPC H04W 72/20

(57) ABSTRACT

Various aspects of the present disclosure generally relate to wireless communication. In some aspects, a user equipment (UE) may transmit, to a network node, a communication including a measurement gap (MG) skipping indication associated with skipping measurements to be performed within a skipped MG occasion. The UE may perform a wireless communication operation in association with the MG skipping indication. Numerous other aspects are described.

### FIELD OF THE DISCLOSURE

Aspects of the present disclosure generally relate to wireless communication and to techniques and apparatuses for indicating measurement gap skipping.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include one or more memories and one or more processors coupled to the one or more memories. The one or more processors may be configured to transmit, to a network node, a communication including a measurement gap (MG) skipping indication associated with skipping measurements to be performed within a skipped MG occasion. The one or more processors may be configured to perform a wireless communication operation in association with the MG skipping indication.

Some aspects described herein relate to a network node for wireless communication. The network node may include one or more memories and one or more processors coupled to the one or more memories. The one or more processors may be configured to receive, from a UE, a communication including an MG skipping indication associated with skipping measurements to be performed within a skipped MG occasion. The one or more processors may be configured to perform a wireless communication operation in association with the MG skipping indication.

Some aspects described herein relate to a method of wireless communication performed by a UE. The method may include transmitting, to a network node, a communication including an MG skipping indication associated with skipping measurements to be performed within a skipped MG occasion. The method may include performing a wireless communication operation in association with the MG skipping indication.

Some aspects described herein relate to a method of wireless communication performed by a network node. The method may include receiving, from a UE, a communication including an MG skipping indication associated with skipping measurements to be performed within a skipped MG occasion. The method may include performing a wireless communication operation in association with the MG skipping indication.

Some aspects described herein relate to a non-transitory computer-readable medium that stores a set of instructions for wireless communication by a UE. The set of instructions, when executed by one or more processors of the UE, may cause the UE to transmit, to a network node, a communication including an MG skipping indication associated with skipping measurements to be performed within a skipped MG occasion. The set of instructions, when executed by one or more processors of the UE, may cause the UE to perform a wireless communication operation in association with the MG skipping indication.

Some aspects described herein relate to a non-transitory computer-readable medium that stores a set of instructions for wireless communication by a network node. The set of instructions, when executed by one or more processors of the network node, may cause the network node to receive, from a UE, a communication including an MG skipping indication associated with skipping measurements to be performed within a skipped MG occasion. The set of instructions, when executed by one or more processors of the network node, may cause the network node to perform a wireless communication operation in association with the MG skipping indication.

Some aspects described herein relate to an apparatus for wireless communication. The apparatus may include means for transmitting, to a network node, a communication including an MG skipping indication associated with skipping measurements to be performed within a skipped MG occasion. The apparatus may include means for performing a wireless communication operation in association with the MG skipping indication.

Some aspects described herein relate to an apparatus for wireless communication. The apparatus may include means for receiving, from a UE, a communication including an MG skipping indication associated with skipping measurements to be performed within a skipped MG occasion. The apparatus may include means for performing a wireless communication operation in association with the MG skipping indication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with measurement gaps (MGs), in accordance with the present disclosure.

FIG. 5 is a diagram illustrating an example of uplink configured grant (CG) communication, in accordance with the present disclosure.

FIG. 6 is a diagram illustrating an example associated with indicating MG skipping, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

User equipment (UEs) can adopt a single radio frequency (RF) module to reduce the manufacturing cost and form factor size. A single RF module may not be able to perform inter-frequency measurement while maintaining data traffic with a serving cell. Measurement gaps (MGs) allow the UE to suspend its communication with the serving cell for inter-frequency neighbor cells or inter-radio access technology (RAT) measurements during a certain period. In some cases, however, use of MGs can increase packet delay associated with real-time multimedia traffic (e.g., extended reality (XR) data traffic). In some cases, MGs can increase the transmission time for burst traffic, thereby introducing challenges in meeting packet budget delay (PDB) requirements of multimedia traffic. The UE may perform inter-frequency and intra-frequency measurement for frequency range 1 (FR1) and frequency range 2 (FR2). The length of the measurement gap often accounts for the synchronization signal (SS)/physical broadcast channel (PBCH) block measurement timing configuration (SMTC) window plus some RF tuning time.

As used herein, the term “measurement gaps” may refer to measurement gaps for radio resource management (RRM) measurements associated with neighbor cells (e.g., non-serving cells), network-controlled small gaps, positioning gaps, cross link interference (CLI) gaps, and/or any other type of gap during which a UE has scheduling restrictions that prohibit the UE from transmitting physical uplink shared channel (PUSCH) communications, physical uplink control channel (PUCCH) communications, and/or sounding resource signals (SRS), among other examples, and/or that prohibit the UE from receiving physical downlink shared channel (PDSCH) communications and/or physical downlink control channel (PDCCH) communications, among other examples.

Some aspects of the techniques described herein may include providing a skipping indication associated with MG occasions. For example, in some aspects, a UE may transmit a communication including an MG skipping indication associated with skipping measurements to be performed within an MG occasion. The UE may perform wireless communication operation in association with the MG skipping indication.

In some cases, a UE may be configured with one or more uplink configured grant (CG) configurations. In some cases, a UE may skip one or more CG occasions. In some cases, the UE may multiplex uplink control information (UCI) in a CG physical uplink shared channel (PUSCH) occasion. In some cases, the UE may transmit an indication (a “skipping indication”) associated with one or more skipped CG PUCSH occasions. In some aspects, UCI CG-PUSCH occasions may be used for transmitting the MG skipping indications. In some cases, the UCI may indicate CG-PUSCH skipping and/or MG skipping, thereby mitigating increases in overhead.

In this way, some aspects of the techniques described herein may facilitate indicating skipped MG occasions, allowing for communication of data during those occasions, thereby facilitating more efficient communications in which MGs can be utilized to facilitate communication reliability and/or mobility, while mitigating delays in packet transmission associated with low-latency traffic such as XR data traffic. Accordingly, some aspects may positively impact network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

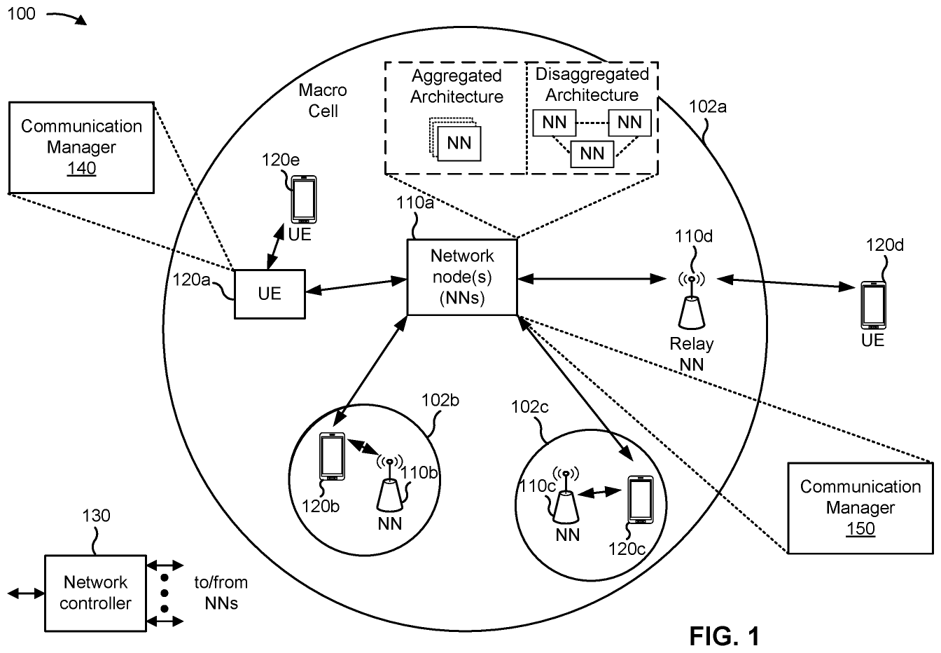

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may transmit, to a network node, a communication including a measurement gap (MG) skipping indication associated with skipping measurements to be performed within a skipped MG occasion; and perform a wireless communication operation in association with the MG skipping indication. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, from a UE, a communication including a MG skipping indication associated with skipping measurements to be performed within a skipped MG occasion; and perform a wireless communication operation in association with the MG skipping indication. Additionally, or alternatively, the communication manager 150 may perform one or more other operations described herein.

As indicated above, FIG. 1 is provided as an example. Other examples may differ from what is described with regard to FIG. 1.

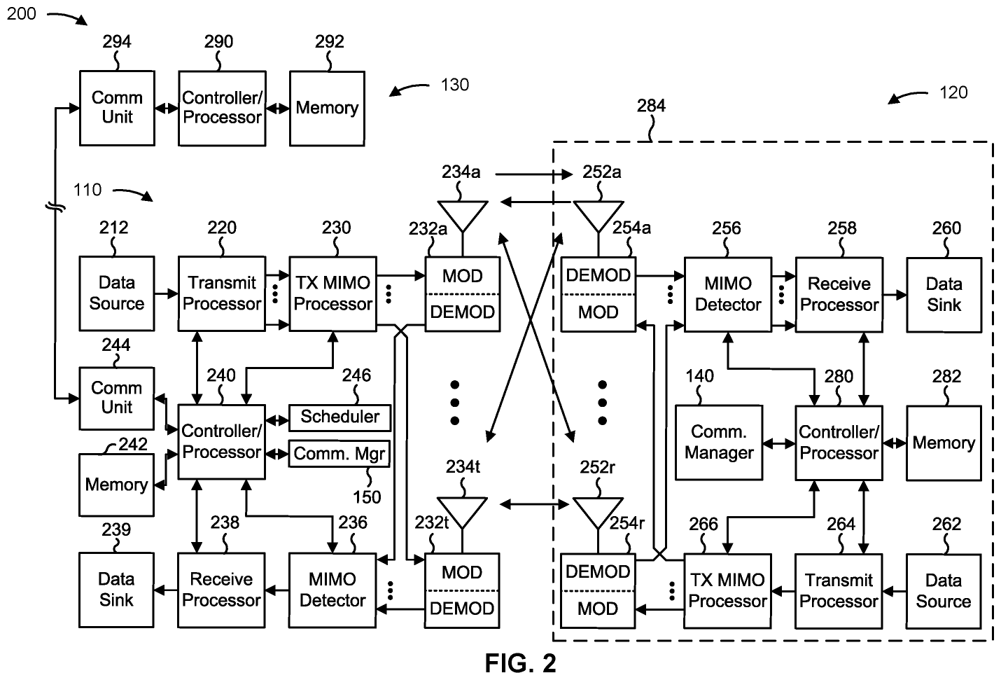

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing May provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

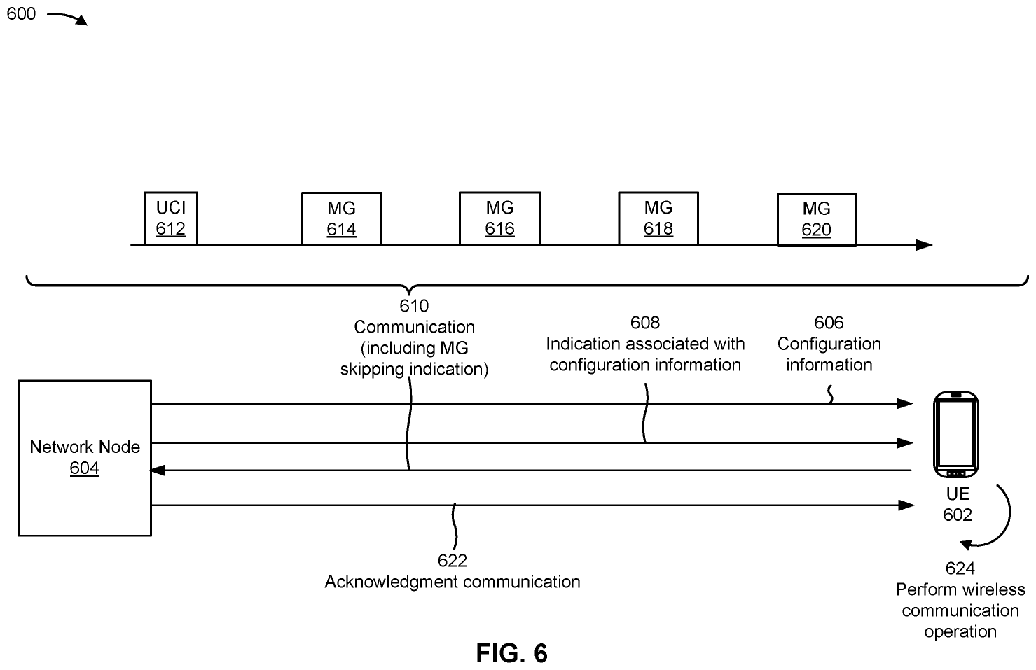

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

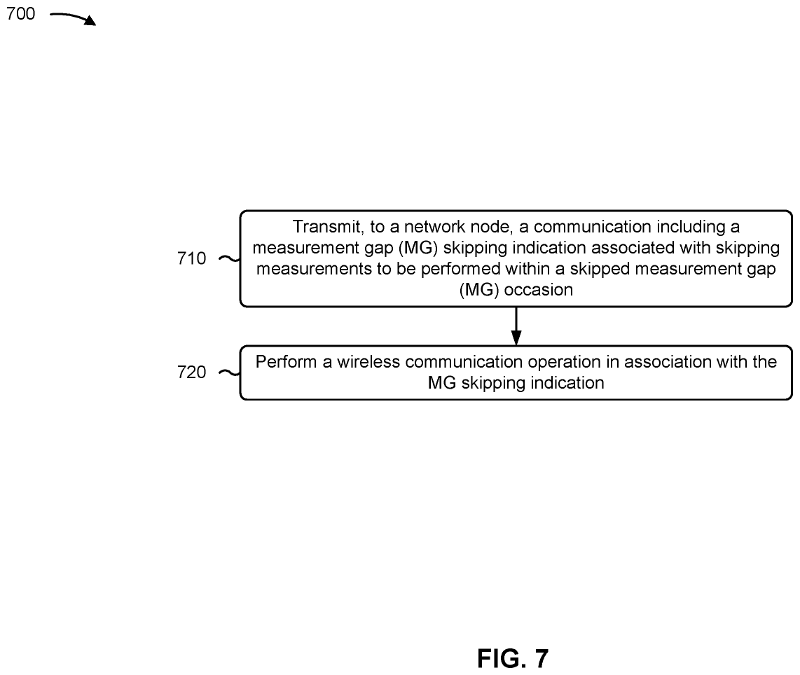

The controller/processor 240 of the network node 110, the controller/processor 280 of the UE 120, and/or any other component(s) of FIG. 2 may perform one or more techniques associated with indicating measurement gap skipping, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a network node, a communication including an MG skipping indication associated with skipping measurements to be performed within a skipped MG occasion; and/or means for performing a wireless communication operation in association with the MG skipping indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, a communication including an MG skipping indication associated with skipping measurements to be performed within a skipped MG occasion; and/or means for performing a wireless communication operation in association with the MG skipping indication. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

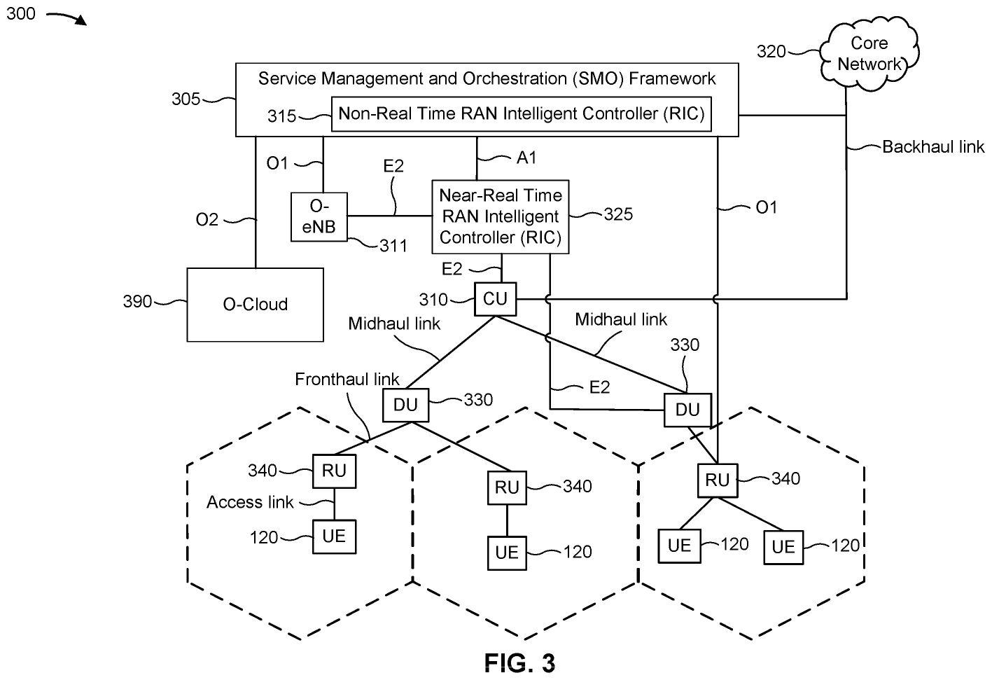

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

High-speed, low-latency and high-reliability wireless connectivity may enable immersive extended reality (XR) multimedia and cloud computing services. To support XR, wireless communication may be required to meet system requirements associated with data rate, latency, and/or power consumption, among other examples. In some aspects, a radio resource management (RRM) measurement gap (MG) may be used to enable UEs to operate in multi-frequency cellular networks.

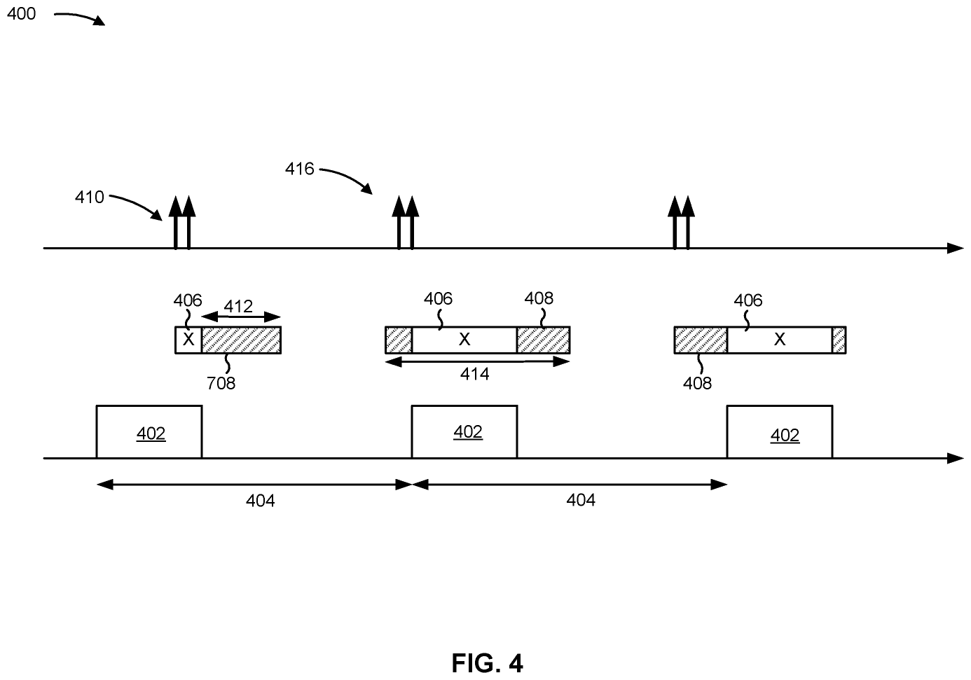

FIG. 4 is a diagram illustrating an example 400 associated with measurement gaps, in accordance with the present disclosure. As shown, for example, MG occasions 402 may occur periodically (e.g., in accordance with an MG period 404). During an MG occasion (sometimes referred to simply as an MG), a UE can measure signals associated with cells neighboring a serving cell to which the UE is connected. In some cases, during an MG occasion, the UE can measure carrier components other than a carrier component on which the UE is currently communicating (e.g., using different frequencies).

For example, in some cases, UEs can adopt a single radio frequency (RF) module to reduce the manufacturing cost and form factor size. A single RF module may not be able to perform inter-frequency measurement while maintaining data traffic with a serving cell. Measurement gaps allow the UE to suspend its communication with the serving cell for inter-frequency neighbor cells or inter-radio access technology (RAT) measurements during a certain period.

In some cases, however, use of MGs can increase packet delay associated with real-time multimedia traffic (e.g., XR data traffic). For example, as shown, the UE may not be able to receive a downlink signal during time periods 406 in which the MG occasions 402 overlap, in time, with physical downlink shared channel (PDSCH) occasions 408. In some cases, the overlap of PDSCH occasions 408 and MG occasions 402 may result from priority rules associated with MGs. For example, in some cases, a MG may have a higher priority than data traffic (e.g., PDSCH traffic and/or physical uplink shared channel (PUSCH) traffic). In some cases, for example, when MGs are configured, the maximum UE peak throughput can be reduced according to the MG length. In commercial networks, the MG can be configured only when the channel quality of the primary cell becomes less than a certain threshold. In this way, the MGs can interrupt the data transmission of multimedia traffic.

In some cases, MGs can increase the transmission time for burst traffic, thereby introducing challenges in meeting packet budget delay (PDB) requirements of multimedia traffic. For example, as shown, a network transceiver may receive a first set 410 of burst traffic at the end of a measurement gap, resulting in a first length 412 of transmission associated with the first set 410 of burst traffic. However, overlap of the measurement gap 402 with the PDSCH occasion 408 may result in a second, longer, length 414 of transmission associated with a second set 416 of burst traffic. In some cases, priority handling issues between MG and receiving PDSCH can be mitigated using configurable priorities between MG and PDSCH. For example, in some cases, XR traffic can be always prioritized over MGs. However, this prioritization techniques can reduce mobility by reducing the opportunity for RRM measurement operations, thereby negatively impacting network performance.

Some aspects of the techniques described herein may include providing a skipping indication associated with MG occasions. For example, in some aspects, a UE may transmit a communication including an MG skipping indication associated with skipping measurements to be performed within an MG occasion. The UE may perform wireless communication operation in association with the MG skipping indication.

As indicated above, FIG. 4 is provided as an example. Other examples may differ from what is described with respect to FIG. 4.

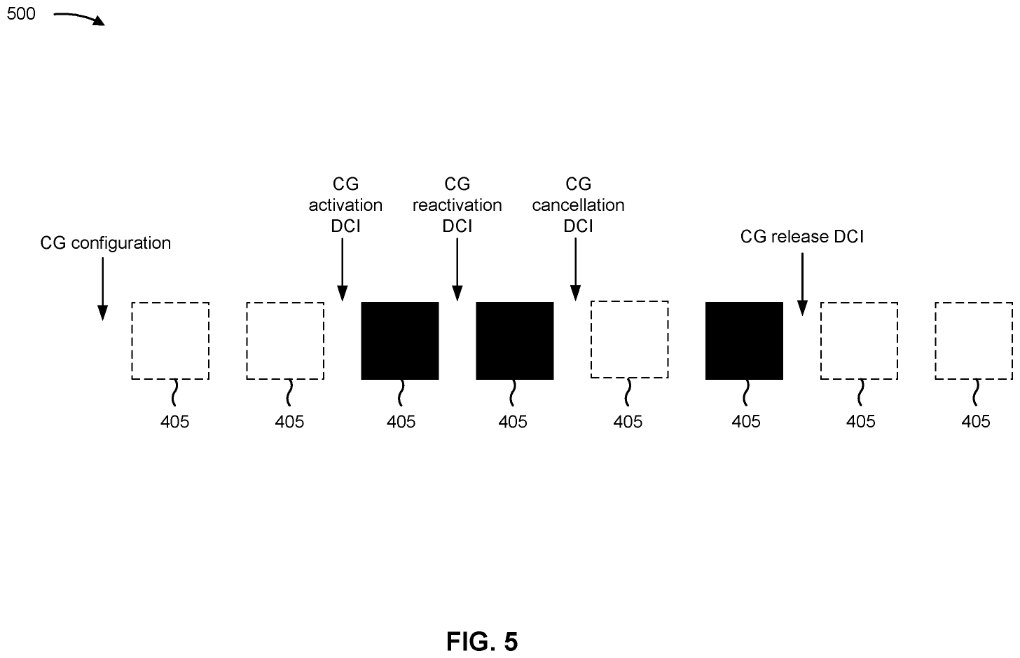

FIG. 5 is a diagram illustrating an example 500 of uplink CG communication, in accordance with the present disclosure. CG communications may include periodic uplink communications that are configured for a UE, such that the network node does not need to send separate downlink control information (DCI) to schedule each uplink communication, thereby conserving signaling overhead.

As shown in example 500, a UE may be configured with a CG configuration for CG communications. For example, the UE may receive the CG configuration via a radio resource control (RRC) message transmitted by a network node. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG instances 505 for the UE. A CG instance 505 can include a CG occasion, a set of CG occasions, or a portion of a CG occasion. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network node may transmit CG activation DCI to the UE to activate the CG configuration for the UE. The network node may indicate, in the CG activation DCI, communication parameters, such as a modulation and coding scheme (MCS), a resource block (RB) allocation, and/or antenna ports, for the CG PUSCH communications to be transmitted in the scheduled CG instances 505. The UE may begin transmitting in the CG instances 505 based at least in part on receiving the CG activation DCI. For example, beginning with a next scheduled CG instance 505 subsequent to receiving the CG activation DCI, the UE may transmit a PUSCH communication in the scheduled CG instances 505 using the communication parameters indicated in the CG activation DCI. The UE may refrain from transmitting in configured CG instances 505 prior to receiving the CG activation DCI.

The network node may transmit CG reactivation DCI to the UE to change the communication parameters for the CG PUSCH communications. Based at least in part on receiving the CG reactivation DCI, the UE may begin transmitting in the scheduled CG instances 505 using the communication parameters indicated in the CG reactivation DCI. For example, beginning with a next scheduled CG instance 505 subsequent to receiving the CG reactivation DCI, the UE may transmit PUSCH communications in the scheduled CG instances 505 based at least in part on the communication parameters indicated in the CG reactivation DCI.

In some cases, such as when the network node needs to override a scheduled CG communication for a higher priority communication, the network node may transmit CG cancellation DCI to the UE to temporarily cancel or deactivate one or more subsequent CG instances 505 for the UE. The CG cancellation DCI may deactivate only a subsequent one CG instance 505 or a subsequent N CG instances 505 (where N is an integer). CG instances 505 after the one or more (e.g., N) CG instances 505 subsequent to the CG cancellation DCI may remain activated. Based at least in part on receiving the CG cancellation DCI, the UE may refrain from transmitting in the one or more (e.g., N) CG instances 505 subsequent to receiving the CG cancellation DCI. As shown in example 500, the CG cancellation DCI cancels one subsequent CG instance 505 for the UE. After the CG instances 505 (or N CG occasions) subsequent to receiving the CG cancellation DCI, the UE may automatically resume transmission in the scheduled CG instances 505.

The network node may transmit CG release DCI to the UE to deactivate the CG configuration for the UE. The UE may stop transmitting in the scheduled CG instances 505 based at least in part on receiving the CG release DCI. For example, the UE may refrain from transmitting in any scheduled CG instances 505 until another CG activation DCI is received from the network node. Whereas the CG cancellation DCI may deactivate only a subsequent one CG instance 505 or a subsequent N CG instances 505, the CG release DCI deactivates all subsequent CG instances 505 for a given CG configuration for the UE until the given CG configuration is activated again by a new CG activation DCI.

In some cases, a UE may skip one or more CG occasions and may indicate the skipped CG PUSCH occasion(s) based on uplink control information (UCI) (e.g., CG-UCI or a new UCI). In some aspects, multiple CG PUSCH transmission occasions may be scheduled in a period of a single CG PUSCH configuration.

In some aspects, UCI CG-PUSCH occasions may be used for transmitting the MG skipping indications. In some cases, the UCI may indicate CG-PUSH skipping and/or MG skipping, thereby mitigating increases in overhead. In this way, some aspects of the techniques described herein may facilitate indicating skipped MG occasions, allowing for communication of data during those occasions, thereby facilitating more efficient communications in which MGs can be utilized to facilitate communication reliability and/or mobility, while mitigating delays in packet transmission associated with low-latency traffic such as XR data traffic. Accordingly, some aspects may positively impact network performance.

As indicated above, FIG. 5 is provided as an example. Other examples may differ from what is described with respect to FIG. 5.

FIG. 6 is a diagram illustrating an example 600 associated with indicating MG skipping, in accordance with the present disclosure. As shown, for example, a UE 602 and a network node 604 may communicate with one another. The UE 602 may be, be similar to, include, or be included in, the UE 120 depicted in FIGS. 1-3. The network node 604 may be, be similar to, include, or be included in, the network node 110 depicted in FIGS. 1 and 2 and/or one or more components of the disaggregated base station architecture 300 depicted in FIG. 3.

As shown by reference number 606, the network node 604 may transmit, and the UE 602 may receive, configuration information. The configuration information may be transmitted via one or more radio resource control (RRC) messages and/or one or more medium access control (MAC) control elements (MAC CEs), among other examples. The configuration information may be indicative of one or more CG configurations. In some aspects, the configuration information may be indicative of one or more configurations associated with one or more sets of skipped MG occasions and/or one or more sets of skipped CG PUSCH occasions. For example, in some aspects, the configuration information may be indicative of a first configuration associated with a set of skipped MG occasions and a second configuration associated with at least one skipped CG-PUSCH occasion.

As shown by reference number 608, the network node 604 may transmit, and the UE 602 may receive, an indication associated with the configuration information. For example, in some aspects, the indication may indicate a selection of one or more CG PUSCH occasions to be skipped, one or more measurement parameters, and/or one or more MG occasions to be skipped, among other examples.

As shown by reference number 610, the UE 602 may transmit, and the network node 604 may receive, a communication including an MG skipping indication. In some aspects, the communication may include a UCI communication 612. In some aspects, the UE 602 may transmit the UCI communication 612 within a predefined period. In some aspects, the UCI communication 612 may override a prior UCI communication transmitted within a predefined period. In some aspects, the UCI communication 612 may include content and the prior UCI communication may include the content. For example, if UCI is transmitted multiple times in a CG period, a new UCI communication may override a prior UCI communication and/or the multiple UCI communications may include consistent content. In some aspects, the communication may include at least one of a PUSCH communication or a physical uplink control channel (PUCCH) communication. In some aspects, the communication may include at least one of UE assistance information (UAI) or a MAC CE.

The MG skipping indication may be associated with skipping measurements to be performed within one or more skipped MG occasions. For example, the MG skipping occasion may indicate that a first MG occasion 614 and a second MG occasion 616 are to be utilized (e.g., for performance of measurements) and that a third MG occasion 618 and a fourth MG occasion 620 are to be skipped (e.g., not utilized for measurements). In some aspects, the MG skipping occasion may explicitly indicate both used and skipped MG occasions, only used MG occasions, or only skipped MG occasions.

In some aspects, the communication may include a bitmap that indicates the one or more skipped MG occasions. In some aspects, the communication may include a codepoint that indicates the one or more skipped MG occasions. In some aspects, the MG skipping indication may indicate the skipped MG occasion based on a determination that a buffer of the UE contains data to be transmitted. In some aspects, the MG skipping indication may indicate at least one utilized MG occasion based on a determination that a buffer of the UE does not contain data to be transmitted.

In some aspects, as shown by reference number 622, the network node 604 may provide, to the UE 602, an acknowledgement communication. For example, in some aspects, the acknowledgment communication may be indicative of at least one of an MG skipping indication, an MG occasion pattern, or a radio resource control configuration associated with at least one MG occasion. As shown by reference number 624, the UE 602 may perform a wireless communication operation. For example, the UE 602 may perform the wireless communication operation in association with the MG skipping indication. In some aspects, the UE 602 may perform the wireless communication operation in association with receiving the acknowledgment communication. In some aspects, the UE 602 may perform the wireless communication autonomously (e.g., without receiving an acknowledgment communication).

In some aspects, the UE 602 may perform the wireless communication operation based on performing a measurement operation associated with at least one MG. For example, in some aspects, the UE 602 may perform a measurement operation based on a priority associated with the at least one MG occasion. In some aspects, the UE 602 may perform the wireless communication operation based on tuning, based on the priority, a radio frequency component to measure at least one synchronization signal block (SSB) or channel state information reference signal (CSI-RS) associated with at least one neighbor network node. In some aspects, the UE 602 may perform the wireless communication operation based on skipping the at least one MG occasion based on a reference signal received power (RSRP) associated with a serving cell satisfying an RSRP threshold. In some aspects, the UE 602 may perform the wireless communication operation based on the indication associated with the configuration information.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 602) performs operations associated with indicating measurement gap status information.

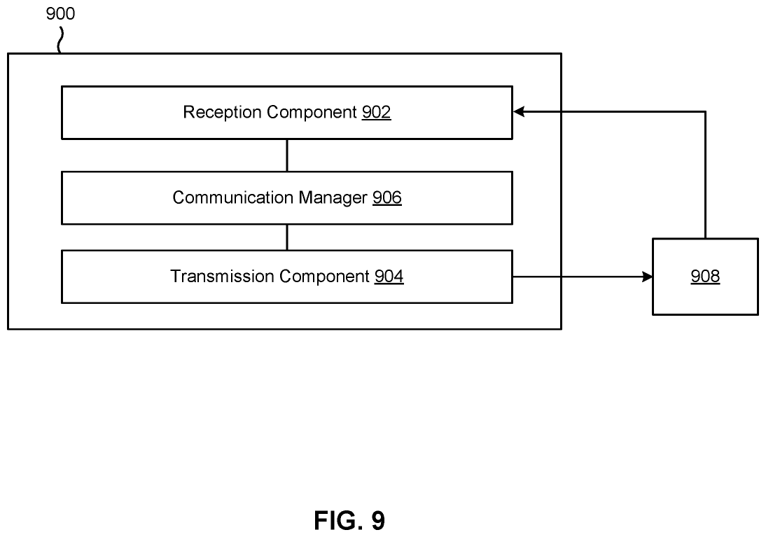

As shown in FIG. 7, in some aspects, process 700 may include transmitting, to a network node, a communication including an MG skipping indication associated with skipping measurements to be performed within a skipped MG occasion (block 710). For example, the UE (e.g., using transmission component 904 and/or communication manager 906, depicted in FIG. 9) may transmit, to a network node, a communication including an MG skipping indication associated with skipping measurements to be performed within a skipped MG occasion, as described above.

As further shown in FIG. 7, in some aspects, process 700 may include performing a wireless communication operation in association with the MG skipping indication (block 720). For example, the UE (e.g., using communication manager 906, depicted in FIG. 9) may perform a wireless communication operation in association with the MG skipping indication, as described above.

Process 700 may include additional aspects, such as any single aspect or any combination of aspects described below and/or in connection with one or more other processes described elsewhere herein.

In a first aspect, the MG skipping indication indicates the skipped MG occasion based on a determination that a buffer of the UE contains data to be transmitted. In a second aspect, alone or in combination with the first aspect, the MG skipping indication indicates at least one utilized MG occasion based on a determination that a buffer of the UE does not contain data to be transmitted. In a third aspect, alone or in combination with one or more of the first and second aspects, performing the wireless communication operation comprises performing a measurement operation associated with at least one MG occasion based on a priority associated with associated with the at least one MG occasion. In a fourth aspect, alone or in combination with the third aspect, process 700 includes, based on the priority, a radio frequency component to measure at least one synchronization signal block associated with at least one neighbor network node. In a fifth aspect, alone or in combination with one or more of the third through fourth aspects, performing the wireless communication operation comprises skipping the at least one MG occasion based on an RSRP associated with a serving cell satisfying an RSRP threshold.

In a sixth aspect, alone or in combination with one or more of the first through fifth aspects, process 700 includes receiving, from the network node, an indication associated with MG configuration information, wherein performing the wireless communication operation comprises performing the wireless communication operation based on the indication. In a seventh aspect, alone or in combination with one or more of the first through sixth aspects, the communication comprises a UCI communication. In an eighth aspect, alone or in combination with the seventh aspect, transmitting the UCI communication comprises transmitting the UCI communication within a predefined period, and the UCI communication overrides a prior UCI communication transmitted within the predefined period. In a ninth aspect, alone or in combination with the eighth aspect, the UCI communication comprises content, and the prior UCI communication comprises the content.

In a tenth aspect, alone or in combination with one or more of the seventh through ninth aspects, process 700 includes receiving an RRC message comprising configuration information indicative of a first configuration associated with a set of skipped MG occasions and a second configuration associated with at least one skipped CG-PUSCH occasion. In an eleventh aspect, alone or in combination with one or more of the seventh through tenth aspects, process 700 includes receiving a MAC CE indicative of a first configuration associated with a set of skipped MG occasions and a second configuration associated at least one skipped CG-PUSCH occasion.

In a twelfth aspect, alone or in combination with one or more of the first through eleventh aspects, the communication comprises a bitmap that indicates the skipped MG occasion. In a thirteenth aspect, alone or in combination with one or more of the first through twelfth aspects, the communication comprises a codepoint that indicates the skipped MG occasion. In a fourteenth aspect, alone or in combination with one or more of the first through thirteenth aspects, the communication comprises at least one of a physical uplink shared channel communication or a physical uplink control channel communication. In a fifteenth aspect, alone or in combination with one or more of the first through fourteenth aspects, process 700 includes receiving, from the network node, an acknowledgement communication indicative of at least one of an MG skipping indication, an MG occasion pattern, or a radio resource control configuration associated with at least one MG occasion. In a sixteenth aspect, alone or in combination with one or more of the first through fifteenth aspects, the communication comprises at least one of UE assistance information or a MAC CE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

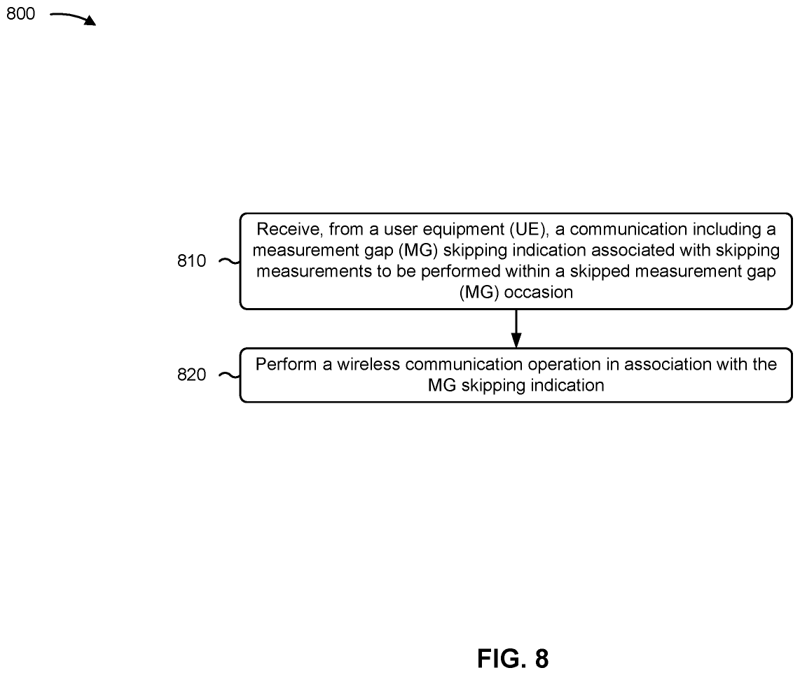

FIG. 8 is a diagram illustrating an example process 800 performed, for example, by a network node, in accordance with the present disclosure. Example process 800 is an example where the network node (e.g., network node 604) performs operations associated with indicating measurement gap status information.

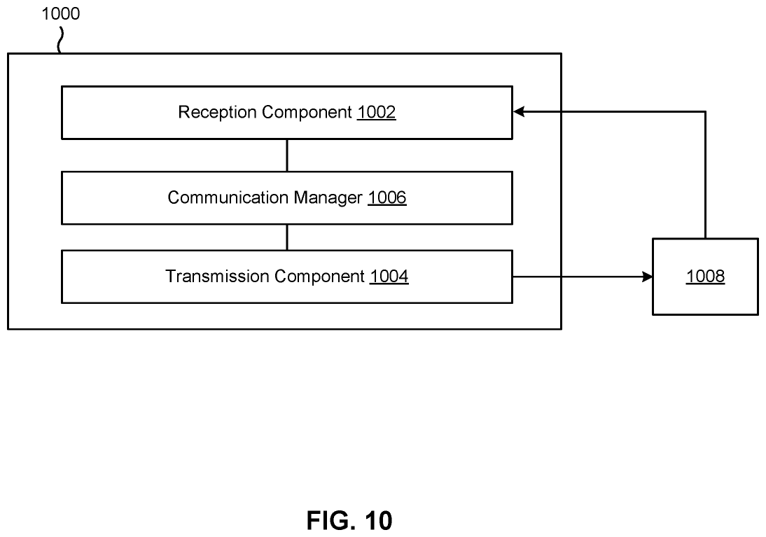

As shown in FIG. 8, in some aspects, process 800 may include receiving, from a UE, a communication including an MG skipping indication associated with skipping measurements to be performed within a skipped MG occasion (block 810). For example, the network node (e.g., using reception component 1002 and/or communication manager 1006, depicted in FIG. 10) may receive, from a UE, a communication including an MG skipping indication associated with skipping measurements to be performed within a skipped MG occasion, as described above.

As further shown in FIG. 8, in some aspects, process 800 may include performing a wireless communication operation in association with the MG skipping indication (block 820). For example, the network node (e.g., using communication manager 1006, depicted in FIG. 10) may perform a wireless communication operation in association with the MG skipping indication, as described above.

Process 800 may include additional aspects, such as any single aspect or any combination of aspects described below and/or in connection with one or more other processes described elsewhere herein.

In a first aspect, the MG skipping indication indicates the skipped MG occasion based on a determination that a buffer of the UE contains data to be transmitted. In a second aspect, alone or in combination with the first aspect, the MG skipping indication indicates at least one utilized MG occasion based on a determination that a buffer of the UE does not contain data to be transmitted. In a third aspect, alone or in combination with one or more of the first and second aspects, process 800 includes transmitting, to the UE, an indication associated with MG configuration information, wherein performing the wireless communication operation comprises performing the wireless communication operation based on the indication. In a fourth aspect, alone or in combination with one or more of the first through third aspects, the communication comprises a UCI communication. In a fifth aspect, alone or in combination with the fourth aspect, receiving the UCI communication comprises receiving the UCI communication within a predefined period, and the UCI communication overrides a prior UCI communication transmitted within the predefined period. In a sixth aspect, alone or in combination with the fifth aspect, the UCI communication comprises content, and the prior UCI communication comprises the content.

In a seventh aspect, alone or in combination with the sixth aspect, process 800 includes transmitting an RRC message comprising configuration information indicative of a first configuration associated with a set of skipped MG occasions and a second configuration associated with at least one skipped CG-PUSCH occasion. In an eighth aspect, alone or in combination with the sixth aspect, process 800 includes transmitting a MAC CE indicative of a first configuration associated with a set of skipped MG occasions and a second configuration associated at least one skipped CG-PUSCH occasion. In a ninth aspect, alone or in combination with one or more of the first through eighth aspects, the communication comprises a bitmap that indicates the skipped MG occasion.

In a tenth aspect, alone or in combination with one or more of the first through ninth aspects, the communication comprises a codepoint that indicates the skipped MG occasion. In an eleventh aspect, alone or in combination with one or more of the first through tenth aspects, the communication comprises at least one of a physical uplink shared channel communication or a physical uplink control channel communication. In a twelfth aspect, alone or in combination with one or more of the first through eleventh aspects, process 800 includes transmitting, to the UE, an acknowledgement communication indicative of at least one of an MG skipping indication, an MG occasion pattern, or a radio resource control configuration associated with at least one MG occasion. In a thirteenth aspect, alone or in combination with one or more of the first through twelfth aspects, the communication comprises at least one of UE assistance information or a MAC CE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a network node, a communication including an MG skipping indication associated with skipping measurements to be performed within a skipped MG occasion. The communication manager 906 may perform a wireless communication operation in association with the MG skipping indication. The communication manager 906 may, based on the priority, a radio frequency component to measure at least one synchronization signal block associated with at least one neighbor network node. The reception component 902 may receive, from the network node, an indication associated with MG configuration information, wherein performing the wireless communication operation comprises performing the wireless communication operation based on the indication.

The reception component 902 may receive an RRC message comprising configuration information indicative of a first configuration associated with a set of skipped MG occasions and a second configuration associated with at least one skipped CG-PUSCH occasion. The reception component 902 may receive a MAC CE indicative of a first configuration associated with a set of skipped MG occasions and a second configuration associated at least one skipped CG-PUSCH occasion. The reception component 902 may receive, from the network node, an acknowledgement communication indicative of at least one of an MG skipping indication, an MG occasion pattern, or a radio resource control configuration associated with at least one MG occasion.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a UE, a communication including an MG skipping indication associated with skipping measurements to be performed within a skipped MG occasion. The communication manager 1006 may perform a wireless communication operation in association with the MG skipping indication. The transmission component 1004 may transmit, to the UE, an indication associated with MG configuration information, wherein performing the wireless communication operation comprises performing the wireless communication operation based on the indication. The transmission component 1004 may transmit an RRC message comprising configuration information indicative of a first configuration associated with a set of skipped MG occasions and a second configuration associated with at least one skipped CG-PUSCH occasion. The transmission component 1004 may transmit a MAC CE indicative of a first configuration associated with a set of skipped MG occasions and a second configuration associated at least one skipped CG-PUSCH occasion. The transmission component 1004 may transmit, to the UE, an acknowledgement communication indicative of at least one of an MG skipping indication, an MG occasion pattern, or a radio resource control configuration associated with at least one MG occasion.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting, to a network node, a communication including a measurement gap (MG) skipping indication associated with skipping measurements to be performed within a skipped MG occasion; and performing a wireless communication operation in association with the MG skipping indication.

Aspect 2: The method of Aspect 1, wherein the MG skipping indication indicates the skipped MG occasion based on a determination that a buffer of the UE contains data to be transmitted.

Aspect 3: The method of either of claim 1 or 2, wherein the MG skipping indication indicates at least one utilized MG occasion based on a determination that a buffer of the UE does not contain data to be transmitted.

Aspect 4: The method of any of Aspects 1-3, wherein performing the wireless communication operation comprises performing a measurement operation associated with at least one MG occasion based on a priority associated with associated with the at least one MG occasion.

Aspect 5: The method of Aspect 4, further comprising tuning, based on the priority, a radio frequency component to measure at least one synchronization signal block associated with at least one neighbor network node.

Aspect 6: The method of either of claim 4 or 5, wherein performing the wireless communication operation comprises skipping the at least one MG occasion based on a reference signal received power (RSRP) associated with a serving cell satisfying an RSRP threshold.

Aspect 7: The method of any of Aspects 1-6, further comprising receiving, from the network node, an indication associated with MG configuration information, wherein performing the wireless communication operation comprises performing the wireless communication operation based on the indication.

Aspect 8: The method of any of Aspects 1-7, wherein the communication comprises an uplink control information (UCI) communication.

Aspect 9: The method of Aspect 8, wherein transmitting the UCI communication comprises transmitting the UCI communication within a predefined period, and wherein the UCI communication overrides a prior UCI communication transmitted within the predefined period.

Aspect 10: The method of Aspect 9, wherein the UCI communication comprises content, and wherein the prior UCI communication comprises the content.

Aspect 11: The method of any of Aspects 8-10, further comprising receiving a radio resource control (RRC) message comprising configuration information indicative of a first configuration associated with a set of skipped MG occasions and a second configuration associated with at least one skipped configured grant (CG)-physical uplink shared channel (PUSCH) occasion.

Aspect 12: The method of any of Aspects 8-11, further comprising receiving a medium access control (MAC) control element (MAC CE) indicative of a first configuration associated with a set of skipped MG occasions and a second configuration associated at least one skipped configured grant (CG)-physical uplink shared channel (PUSCH) occasion.

Aspect 13: The method of any of Aspects 1-12, wherein the communication comprises a bitmap that indicates the skipped MG occasion.

Aspect 14: The method of any of Aspects 1-13, wherein the communication comprises a codepoint that indicates the skipped MG occasion.

Aspect 15: The method of any of Aspects 1-14, wherein the communication comprises at least one of a physical uplink shared channel communication or a physical uplink control channel communication.

Aspect 16: The method of any of Aspects 1-15, further comprising receiving, from the network node, an acknowledgement communication indicative of at least one of an MG skipping indication, an MG occasion pattern, or a radio resource control configuration associated with at least one MG.

Aspect 17: The method of any of Aspects 1-16, wherein the communication comprises at least one of UE assistance information or a medium access control (MAC) control element (MAC CE).

Aspect 18: A method of wireless communication performed by a network node, comprising: receiving, from a user equipment (UE), a communication including a measurement gap (MG) skipping indication associated with skipping measurements to be performed within a skipped MG occasion; and performing a wireless communication operation in association with the MG skipping indication.

Aspect 19: The method of Aspect 18, wherein the MG skipping indication indicates the skipped MG occasion based on a determination that a buffer of the UE contains data to be transmitted.

Aspect 20: The method of either of claim 18 or 19, wherein the MG skipping indication indicates at least one utilized MG occasion based on a determination that a buffer of the UE does not contain data to be transmitted.

Aspect 21: The method of any of Aspects 18-20, further comprising transmitting, to the UE, an indication associated with MG configuration information, wherein performing the wireless communication operation comprises performing the wireless communication operation based on the indication.

Aspect 22: The method of any of Aspects 18-21, wherein the communication comprises an uplink control information (UCI) communication.

Aspect 23: The method of Aspect 22, wherein receiving the UCI communication comprises receiving the UCI communication within a predefined period, and wherein the UCI communication overrides a prior UCI communication transmitted within the predefined period.

Aspect 24: The method of Aspect 23, wherein the UCI communication comprises content, and wherein the prior UCI communication comprises the content.

Aspect 25: The method of Aspect 24, further comprising transmitting a radio resource control (RRC) message comprising configuration information indicative of a first configuration associated with a set of skipped MG occasions and a second configuration associated with at least one skipped configured grant (CG)-physical uplink shared channel (PUSCH) occasion.

Aspect 26: The method of Aspect 24, further comprising transmitting a medium access control (MAC) control element (MAC CE) indicative of a first configuration associated with a set of skipped MG occasions and a second configuration associated at least one skipped configured grant (CG)-physical uplink shared channel (PUSCH) occasion.

Aspect 27: The method of any of Aspects 18-26, wherein the communication comprises a bitmap that indicates the skipped MG occasion.

Aspect 28: The method of any of Aspects 18-27, wherein the communication comprises a codepoint that indicates the skipped MG occasion.

Aspect 29: The method of any of Aspects 18-28, wherein the communication comprises at least one of a physical uplink shared channel communication or a physical uplink control channel communication.

Aspect 30: The method of any of Aspects 18-29, further comprising transmitting, to the UE, an acknowledgement communication indicative of at least one of an MG skipping indication, an MG occasion pattern, or a radio resource control configuration associated with at least one MG occasion.

Aspect 31: The method of any of Aspects 18-30, wherein the communication comprises at least one of UE assistance information or a medium access control (MAC) control element (MAC CE).

Aspect 32: An apparatus for wireless communication at a device, comprising a processor; memory coupled with the processor; and instructions stored in the memory and executable by the processor to cause the apparatus to perform the method of one or more of Aspects 1-17.

Aspect 33: A device for wireless communication, comprising a memory and one or more processors coupled to the memory, the one or more processors configured to perform the method of one or more of Aspects 1-17.

Aspect 34: An apparatus for wireless communication, comprising at least one means for performing the method of one or more of Aspects 1-17.

Aspect 35: A non-transitory computer-readable medium storing code for wireless communication, the code comprising instructions executable by a processor to perform the method of one or more of Aspects 1-17.

Aspect 36: A non-transitory computer-readable medium storing a set of instructions for wireless communication, the set of instructions comprising one or more instructions that, when executed by one or more processors of a device, cause the device to perform the method of one or more of Aspects 1-17.

Aspect 37: An apparatus for wireless communication at a device, comprising a processor; memory coupled with the processor; and instructions stored in the memory and executable by the processor to cause the apparatus to perform the method of one or more of Aspects 18-31.

Aspect 38: A device for wireless communication, comprising a memory and one or more processors coupled to the memory, the one or more processors configured to perform the method of one or more of Aspects 18-31.

Aspect 39: An apparatus for wireless communication, comprising at least one means for performing the method of one or more of Aspects 18-31.

Aspect 40: A non-transitory computer-readable medium storing code for wireless communication, the code comprising instructions executable by a processor to perform the method of one or more of Aspects 18-31.

Aspect 41: A non-transitory computer-readable medium storing a set of instructions for wireless communication, the set of instructions comprising one or more instructions that, when executed by one or more processors of a device, cause the device to perform the method of one or more of Aspects 18-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
transmit, to a network node, a communication including a measurement gap (MG) skipping indication associated with skipping measurements to be performed within a skipped MG occasion; and
perform a wireless communication operation in association with the MG skipping indication.

2. The UE of claim 1, wherein the MG skipping indication indicates the skipped MG occasion based on a determination that a buffer of the UE contains data to be transmitted.

3. The UE of claim 1, wherein the MG skipping indication indicates at least one utilized MG occasion based on a determination that a buffer of the UE does not contain data to be transmitted.

4. The UE of claim 1, wherein the one or more processors, to perform the wireless communication operation, are configured to cause the UE to perform a measurement operation associated with at least one MG occasion based on a priority associated with associated with the at least one MG occasion.

5. The UE of claim 4, wherein the one or more processors are further configured to cause the UE to, based on the priority, a radio frequency component to measure at least one synchronization signal block associated with at least one neighbor network node.

6. The UE of claim 4, wherein the one or more processors, to cause the UE to perform the wireless communication operation, are configured to cause the UE to skip the at least one MG occasion based on a reference signal received power (RSRP) associated with a serving cell satisfying an RSRP threshold.

7. The UE of claim 1, wherein the one or more processors are further configured to cause the UE to receive, from the network node, an indication associated with MG configuration information, wherein the one or more processors, to cause the UE to perform the wireless communication operation, are configured to cause the UE to perform the wireless communication operation based on the indication.

8. The UE of claim 1, wherein the communication comprises an uplink control information (UCI) communication.

9. The UE of claim 8, wherein the one or more processors, to cause the UE to transmit the UCI communication, are configured to cause the UE to transmit the UCI communication within a predefined period, and wherein the UCI communication overrides a prior UCI communication transmitted within the predefined period.

10. The UE of claim 9, wherein the UCI communication comprises content, and wherein the prior UCI communication comprises the content.

11. The UE of claim 8, wherein the one or more processors are further configured to cause the UE to receive a radio resource control (RRC) message comprising configuration information indicative of a first configuration associated with a set of skipped MG occasions and a second configuration associated with at least one skipped configured grant (CG)-physical uplink shared channel (PUSCH) occasion.

12. The UE of claim 8, wherein the one or more processors are further configured to cause the UE to receive a medium access control (MAC) control element (MAC CE) indicative of a first configuration associated with a set of skipped MG occasions and a second configuration associated at least one skipped configured grant (CG)-physical uplink shared channel (PUSCH) occasion.

13. The UE of claim 1, wherein the communication comprises a bitmap that indicates the skipped MG occasion.

14. The UE of claim 1, wherein the communication comprises a codepoint that indicates the skipped MG occasion.

15. The UE of claim 1, wherein the communication comprises at least one of a physical uplink shared channel communication or a physical uplink control channel communication.

16. The UE of claim 1, wherein the one or more processors are further configured to cause the UE to receive, from the network node, an acknowledgement communication indicative of at least one of an MG skipping indication, an MG occasion pattern, or a radio resource control configuration associated with at least one MG.

17. The UE of claim 1, wherein the communication comprises at least one of UE assistance information or a medium access control (MAC) control element (MAC CE).

18. A network node for wireless communication, comprising:
one or more memories; and
one or more processors, coupled to the one or more memories, configured to cause the network node to:
receive, from a user equipment (UE), a communication including a measurement gap (MG) skipping indication associated with skipping measurements to be performed within a skipped MG occasion; and
perform a wireless communication operation in association with the MG skipping indication.

19. The network node of claim 18, wherein the MG skipping indication indicates the skipped MG occasion based on a determination that a buffer of the UE contains data to be transmitted.

20. The network node of claim 18, wherein the MG skipping indication indicates at least one utilized MG occasion based on a determination that a buffer of the UE does not contain data to be transmitted.

21. The network node of claim 18, wherein the one or more processors are further configured to cause the network node to transmit, to the UE, an indication associated with MG configuration information, wherein the one or more processors, to cause the network node to perform the wireless communication operation, are configured to cause the network node to perform the wireless communication operation based on the indication.

22. The network node of claim 18, wherein the communication comprises an uplink control information (UCI) communication.

23. The network node of claim 18, wherein the communication comprises at least one of a bitmap that indicates the skipped MG occasion or a codepoint that indicates the skipped MG occasion.

24. The network node of claim 18, wherein the communication comprises at least one of a physical uplink shared channel communication or a physical uplink control channel communication.

25. The network node of claim 18, wherein the one or more processors are further configured to cause the network node to transmit, to the UE, an acknowledgement communication indicative of at least one of an MG skipping indication, an MG occasion pattern, or a radio resource control configuration associated with at least one MG occasion.

26. The network node of claim 18, wherein the communication comprises at least one of UE assistance information or a medium access control (MAC) control element (MAC CE).

27. A method of wireless communication performed by a user equipment (UE), comprising:
transmitting, to a network node, a communication including a measurement gap (MG) skipping indication associated with skipping measurements to be performed within a skipped MG occasion; and
performing a wireless communication operation in association with the MG skipping indication.

28. The method of claim 27, wherein the communication comprises an uplink control information (UCI) communication.

29. A method of wireless communication performed by a network node, comprising:
receiving, from a user equipment (UE), a communication including a measurement gap (MG) skipping indication associated with skipping measurements to be performed within a skipped MG occasion; and
performing a wireless communication operation in association with the MG skipping indication.

30. The method of claim 29, wherein the communication comprises an uplink control information (UCI) communication.
